(19) United States
(12) Patent Application Publication
(10) Pub. No.: US 2026/0302394 A1
(43) Pub. Date: Oct. 1, 2026

(54) FIRE RESPONSE SYSTEM FOR BATTERY CHARGING AND DISCHARGING PROCESS AND FIRE RESPONSE METHOD USING THE SAME

(71) Applicant: SK On Co., Ltd., Seoul (KR)

(72) Inventors: Geon Hee LEE, Daejeon (KR); Yun Jo JUNG, Daejeon (KR); Eun Sol GO, Daejeon (KR); Jae Hyeok YU, Daejeon (KR)

(21) Appl. No.: 19/632,417

(22) Filed: Mar. 30, 2026

(30) Foreign Application Priority Data
Mar. 31, 2025 (KR) 10-2025-0041234

(51) Int. Cl. H01M 10/44; H01M 10/48

(52) U.S. Cl. CPC H01M 10/443; H01M 10/486

(57) ABSTRACT

The present disclosure relates to a fire response system for a battery charging and discharging process, including: a tray accommodating one or more battery cells; a charging/discharging portion including one or more terminals applying current to the battery cell; a first sensor sensing a first temperature, which is a temperature of heat generated in the battery cell; a second sensor sensing a first concentration, which is a concentration of exhaust fume released from the battery cells; and a controller controlling an operation of the charging/discharging portion based on information received from any one of the first and second sensors.

### CROSS-REFERENCE TO RELATED PATENT APPLICATION

The present application claims priority under 35 U.S.C. § 119(a) to Korean patent application number 10-2025-0041234 filed on Mar. 31, 2025, in the Ministry of Intellectual Property, the entire disclosure of which is incorporated by reference herein.

### BACKGROUND OF THE INVENTION

### 1. FIELD

The present disclosure relates to a fire response system for a battery charging and discharging process and a fire response method using the same.

### 2. DESCRIPTION OF THE RELATED ART

The demand for batteries is steadily increasing owing to rechargeability, compact size, and a potential for high capacity. These batteries have been widely used as power sources for mobile phones, laptops, and electric vehicles, either as individual battery cells packaged into a form of battery packs or as multiple battery cells interconnected to form a battery pack.

Batteries may consist of a positive electrode, a negative electrode, and an electrolyte, and typically graphite is used for the negative electrode, and oxide, including lithium, is used for the positive electrode. Batteries containing lithium may generate high heat in abnormal modes such as vibration, shock, drop, high temperature storage, and overcharging, which may lead to sparking and ignition in an excessive case. In addition, in the event of a fire, these batteries may generate strong flames and heat, causing other batteries to chain combust and explode. Therefore, there is an urgent need to prevent fires caused by batteries and secure safety by countermeasure and response technologies to cope with fires at an early stage.

### SUMMARY OF THE INVENTION

Embodiments of the present disclosure may provide a fire response system for a battery charging and discharging process and a fire response method using the same, enabling rapid initialization countermeasure and efficient fire suppression.

Furthermore, embodiments of the present disclosure may provide a fire response system for a battery charging and discharging process and a fire response method using the same, to quickly prevent and cope with a fire that may occur in the battery charging and discharging process.

The present disclosure may be widely applied in the fields of electric vehicles, battery charging stations, energy storage systems (ESS), and other green technologies such as photovoltaics and wind power that utilize batteries. The present disclosure may also be used in eco-friendly mobility, including electric vehicles and hybrid vehicles to prevent climate change by curbing air pollution and greenhouse gas emissions.

An embodiment of the present disclosure includes a fire response system for a battery charging and discharging process and a fire response method using the same.

In an embodiment, the present disclosure includes a fire response system for a battery charging and discharging process, including: a tray accommodating one or more battery cells; a charging/discharging portion including one or more terminals applying current to the battery cells; a first sensor sensing a first temperature, which is a temperature of heat generated in the battery cell; a second sensor sensing a first concentration, which is a concentration of exhaust fume released from the battery cell; and a controller controlling an operation of the charging/discharging portion based on information received from any one of the first and second sensors.

In an embodiment, the first temperature may be greater than or equal to 85° C, and the first concentration may be greater than or equal to 5%.

In an embodiment, the charging/discharging portion may include: a base plate including one or more frames on which the tray is placed; first and second side plates provided side by side in a direction perpendicular to one side of the base plate and facing each other; and one or more terminals provided on the first and second side plates and electrically connected to battery cells; wherein the first and second side plates may be movable, respectively, such that a first distance between the first and second side plates may vary, wherein the tray may be provided between the first and second side plates, and wherein the battery cell may be electrically connected to the terminal.

In an embodiment, the first sensor may be provided in the terminal, and the second sensor may be provided on an upper side of the first and second side plates or on the base plate.

In an embodiment, the controller may include: an information processor receiving and processing information transmitted from the first and second sensors; a data storage storing charging and discharging process data recorded in the charging/discharging portion; a terminal driver controlling electrical connection of the terminal and the battery cell; a jig driver controlling movement of the first and second side plates; and a power manager controlling on-off of power of the charging/discharging portion.

In an embodiment, the controller may further include a tray driver loading the tray from the charging/discharging portion to a stacker crane.

In an embodiment, the fire response system may further include an alarming portion generating an alarm based on information received from any one of the first and second sensors.

In an embodiment, the present disclosure may include a fire response method for a battery charging and discharging process, the method including: transmitting information from at least one of the first sensor or the second sensor to the controller in a process in which one or more battery cells perform a charging and discharging process in a charging/discharging portion; storing charging and discharging process data recorded in the charging/discharging portion; checking connection of the terminal and the battery cell; spacing the terminal from the battery cell; and disconnecting power of the charging/discharging portion, wherein the first sensor may transmit information to the controller when a temperature is a first temperature, and wherein the second sensor may transmit information to the controller when a concentration of exhaust fume is a first concentration.

In an embodiment, the charging and discharging process may be performed by providing the charging/discharging portion with a tray having one or more battery cells, wherein the charging/discharging portion may be provided with one or more terminals to be electrically connected with an electrode terminal of the battery cell.

In an embodiment, the transmitting information to the controller may further include transmitting, by the first and second sensors, information to an alarming portion and generating an alarm in the alarming portion.

In an embodiment, the method may further include, between the spacing from the battery cell and the disconnecting power, loading the tray from the charging/discharging portion to a stacker crane.

According to the present disclosure, a fire response system for a battery charging and discharging process and a fire response method using the same may be provided, enabling quick detection and response to abnormal conditions that occur during battery charging and discharging.

Also, according to the present disclosure, a fire response system for a battery charging and discharging process and a fire response method using the same may be provided, enabling quick prevention and response to a fire that may occur in a battery charging and discharging process.

### BRIEF DESCRIPTION OF THE DRAWINGS

FIG. 1 is a schematic diagram of a fire response system for a battery charging and discharging process according to an embodiment of the present disclosure.

FIG. 2 is a diagram illustrating the fire response system for a battery charging and discharging process of FIG. 1.

FIG. 3 is a diagram illustrating the tray and the charging/discharging portion of FIG. 1.

FIG. 4 is a perspective view of the tray and the charging/discharging portion of FIG. 1.

FIG. 5 is a schematic illustration of a first sensor provided in a terminal according to an embodiment of the present disclosure.

FIG. 6 is a schematic illustration of the controller of FIG. 1.

FIG. 7 is a diagram illustrating a tray and a charging/discharging portion according to another embodiment of the present disclosure.

FIG. 8 is a diagram illustrating a lower side of the terminal of FIG. 7.

FIG. 9 is a flowchart illustrating a fire response method for a battery charging and discharging process, according to an embodiment of the present disclosure.

FIG. 10 is a flowchart of a fire response method for a battery charging and discharging process according to another embodiment of the present disclosure.

### DETAILED DESCRIPTION

The structural or functional descriptions of the embodiments disclosed in this specification or application are exemplified for the purpose of illustrating embodiments in accordance with the technical ideas of the present disclosure only, and embodiments in accordance with the technical ideas of the present disclosure may be practiced in various forms other than those disclosed in this specification or application, and the technical ideas of the present disclosure should not be construed to be limited to the embodiments described in this specification or application.

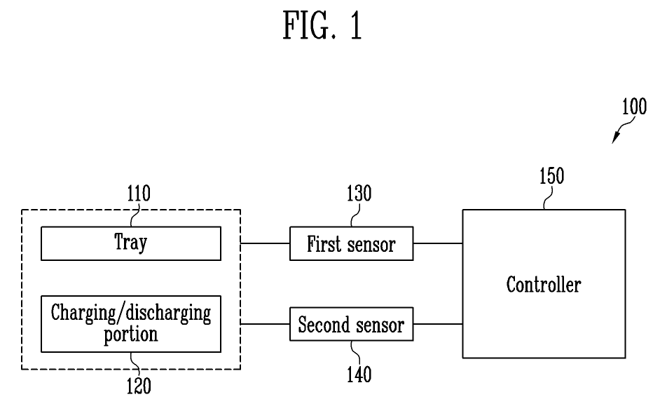

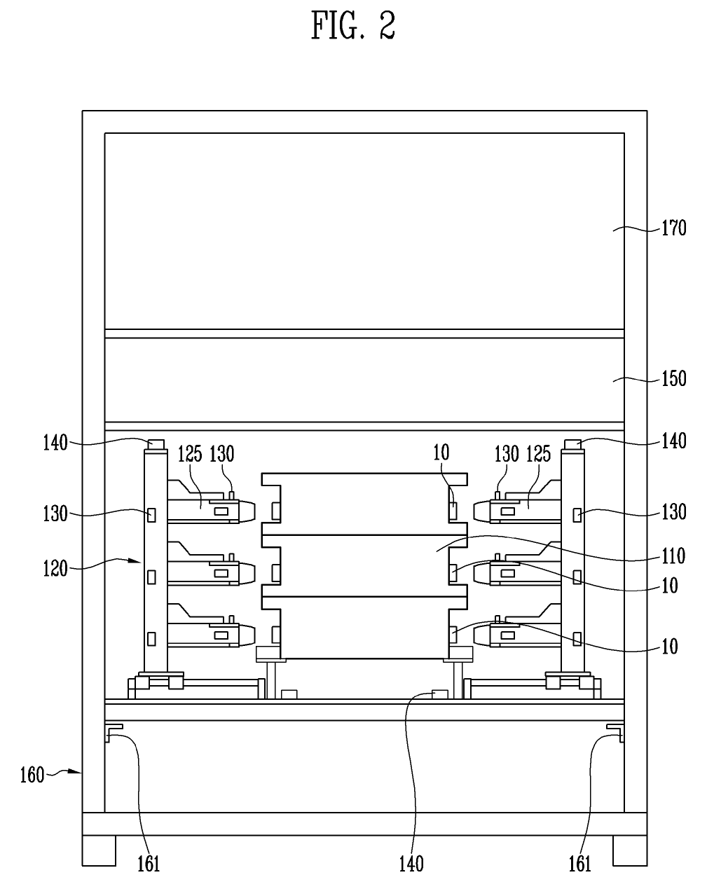

FIG. 1 is a schematic diagram of a fire response system for a battery charging and discharging process according to an embodiment of the present disclosure. FIG. 2 is a diagram illustrating the fire response system for a battery charging and discharging process of FIG. 1.

Referring to FIGS. 1 and 2, a fire response system 100 for a battery charging and discharging process according to an embodiment of the present disclosure includes: a tray 110 accommodating one or more battery cells 10; a charging/discharging portion 120 including one or more terminals 125 applying current to the battery cells 10; a first sensor 130 sensing a first temperature, which is a temperature of heat generated in the battery cell 10; a second sensor 140 sensing a first concentration, which is a concentration of exhaust fume released from the battery cell 10; and a controller 150 controlling an operation of the charging/discharging portion 120 based on information received from any one of the first and second sensors 130, 140.

In general, there has been a problem in factories manufacturing battery cells and the like that there is no system for monitoring and responding to fires that may occur during the battery charging and discharging process. Accordingly, in the related art, in the event of a fire during the battery charging and discharging process, sporadic measures were made by cutting off the power of a charge and discharge apparatus overall, or randomly separating the battery cell undergoing charge and discharge to extinguish the occurring fire. As a result, it was difficult to check a charge and discharge state of the battery cell, and the battery cell had to be charged and discharged again by measuring the state of charge (SOC) overall for the randomly separated battery cell, thereby deteriorating the process efficiency. Moreover, there has been a risk that the fire may significantly expand due to a lack of sequences for a fire response.

On the other hand, the fire response system 100 for a battery charging and discharging process according to the present disclosure may enable determination on whether a fire occurs in advance before an ignition occurs in a battery cell during the battery charging and discharging process, thereby quickly preventing fire. In addition, a systematic fire response sequence may be provided, enabling operators to respond immediately at an early stage and preventing unnecessary accidents or congestion.

A battery cell 10 according to the present disclosure may include an electrode assembly including a negative electrode, a positive electrode, and an electrode terminal, and a case housing the electrode assembly. The battery cell 10 may be capable of charging and discharging multiple times and may include various types of negative electrodes and positive electrodes. The case may be cylindrical, prismatic, and pouch types. The present disclosure describes a battery cell 10 including a pouch-type case, but is not limited thereto. In the battery cell 10, the electrode assembly may be accommodated within the pouch type case. The electrode terminal may include a negative electrode terminal in connection with the negative electrode and a positive electrode terminal in connection with the positive electrode. The negative electrode terminal and the positive electrode terminal may be withdrawn to one side and the other side of the pouch type case, respectively.

One or more of the battery cells 10 may be placed in the tray 110 to be moved to perform the charging and discharging process. The tray 110 may include one or more battery cells 10. The battery cells 10 may be aligned in the tray 110, and the negative electrode terminal and the positive electrode terminal of the battery cells 10 may be provided to be exposed to the outer side of the tray 110. The negative electrode terminal and positive electrode terminal may be electrically connected to the outside, respectively.

The fire response system 100 for a battery charging and discharging process according to an embodiment of the present disclosure may be provided with a first sensor 130 and a second sensor 140. The first sensor 130 may sense a first temperature, which is a temperature caused by heat generated in the battery cell 10, and the second sensor 140 may sense a first concentration, which is a concentration of the exhaust fume generated in the battery cell 10. The first and second sensors 130, 140 may transmit information on the first temperature and the first concentration to the controller 150, and the controller 150 may control the tray 110 and the charging/discharging portion 120 based on the information on the first temperature and the first concentration.

The first temperature may be 85° C or higher, and the first concentration may be 5% or higher. When the first temperature is 85° C or less, in the process of performing charging and discharging, the charging and discharging process may be halted by sensing a temperature caused by heat normally generated by a charging and discharging device or a battery cell, thereby reducing the process efficiency. Specifically, the first temperature may be 87° C or higher, or 90° C or higher, or 92° C or higher. When the first concentration is less than 5%, it may be problematic as it is difficult to accurately detect the exhaust fumes generated in the battery cell 10. Specifically, the first concentration may be 7% or greater, or 10% or greater, or 12% or greater.

The tray 110 and the charging/discharging portion 120 may be placed on a stage 160. The stage 160 may have one or more supports 161 supporting the charging/discharging portion 120. The stage 160 may be provided with a power supply 170 delivering current to the controller 150 and the charging/discharging portion 120. In the process of performing battery charging and discharging, a plurality of stages 160 may be aligned, and the charging and discharging of a plurality of battery cells 10 may be efficiently controlled by using the stage 160 as a unit.

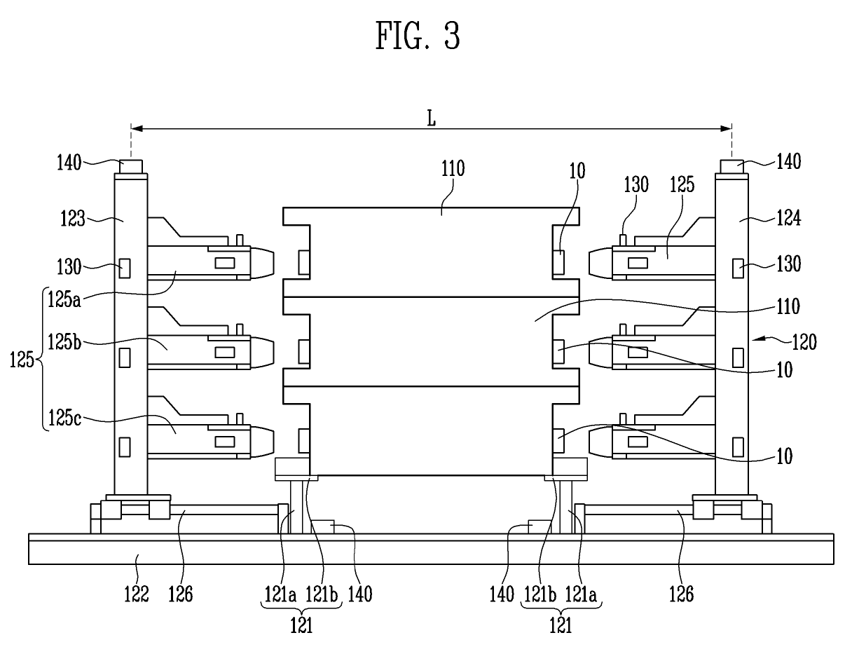

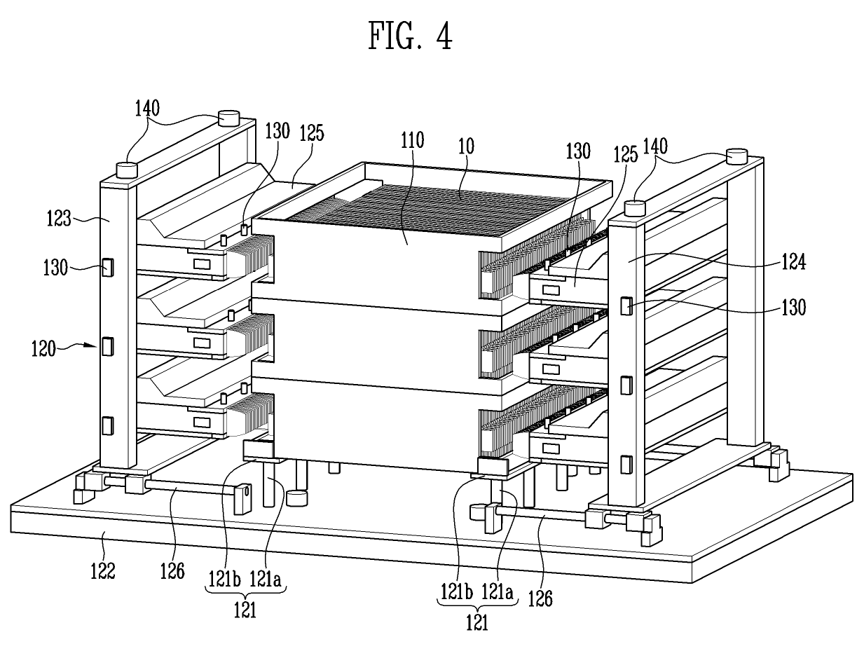

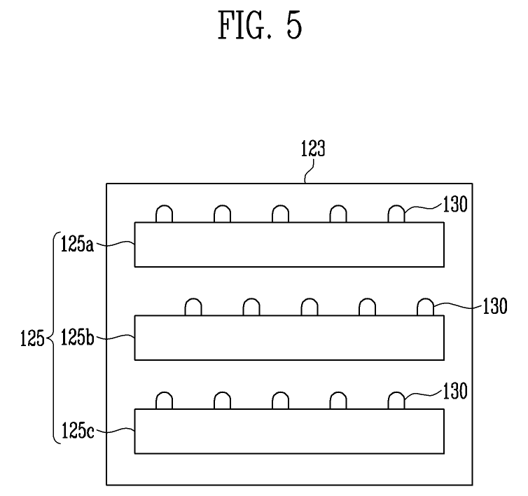

FIG. 3 is a diagram illustrating the tray and the charging/discharging portion of FIG. 1. FIG. 4 is a perspective view of the tray and the charging/discharging portion of FIG. 1. FIG. 5 is a schematic illustration of a first sensor provided in a terminal according to an embodiment of the present disclosure.

Referring to FIGS. 3 and 4, the tray 110 including the battery cell 10 is provided in the charging/discharging portion 120 to perform charging and discharging.

The charging/discharging portion 120 may include: a base plate 122 including one or more frames 121 on which the tray is placed; first and second side plates 123, 124 provided side by side in a direction perpendicular to a first surface of the base plate 122 and facing each other; and one or more terminals 125 provided in the first and second side plates 123, 124 to be electrically connected with the battery cell 10.

The first and second side plates 123, 124 may each be movable, such that a first distance L between the first and second side plates 123, 124 may vary. The tray 110 may be provided between the first and second side plates 123, 124, and the battery cell 10 may be electrically connected with the terminal 125.

The base plate 122 may support the first and second side plates 123, 124 and the tray 110. The first and second side plates 123, 124 may be provided in pairs to face each other. The first and second side plates 123, 124 may each be provided with one or more terminals 125 to be electrically connected with the battery cell 10.

The terminal 125 provided on the first side plate 123 may be provided in a direction facing the second side plate 124, and the terminal 125 provided on the second side plate 124 may be provided in a direction facing the first side plate 123. The first distance L between the first and second side plates 123, 124 may be configured to change reversibly, so that the distance between the terminal provided on the first side plate 123 and the terminal 125 provided on the second side plate 124 may also be configured to change reversibly.

By varying the first distance L between the first and second side plates 123, 124, the battery cell 10 with various sizes may be effectively charged and discharged. When the terminal 125 of the first side plate 123 is connected to the positive electrode terminal of the battery cell 10, the terminal 125 of the second side plate 124 is connected to the negative electrode terminal of the battery cell 10 to perform charging and discharging for the battery cell 10.

The lower sides of the first and second side plates 123, 124 may be provided with a transfer member 126, respectively. The transfer member 126 may be provided in the base plate 122 to move the first and second side plates 123, 124. The transfer member 126 may be provided in a sliding structure having a reversibly varying length, and may change the first distance L between the first and second side plates 123, 124 according to the varying length of the sliding structure.

The sequence of operations in which the tray 110 is provided in the charging/discharging portion 120 is described as follows.

The tray 110 may be provided between the first and second side plates 123, 124 in a state in which the first distance L between the first and second side plates 123, 124 is spaced apart from each other. The first and second side plates 123, 124 may be advanced in a direction toward each other such that the first distance L decreases. The terminal 125 may fix the negative electrode terminal and the positive electrode terminal of the battery cell 10 respectively to perform the charging and discharging process. After the charging and discharging process is completed, the terminal 125 is separated from the negative electrode terminal and the positive electrode terminal, and the first and second side plates 123, 124 may be respectively moved backward so that the first distance L increases. After the first distance L increases, the tray 110 is released to the outer side of the charging/discharging portion 120, and the charging/discharging portion 120 may be kept in a standby state until the next trays 110 is delivered, with the space between the first and second side plates 123, 124 empty.

A plurality of terminals 125 may be aligned. The terminal 125 may be provided to correspond to the position of the battery cell 10 provided in the tray 110. The terminal 125 may be provided in the form of clips or the like. Each of the positive electrode terminal and the negative electrode terminal protruding from the battery cell 10 in both directions may be gripped and fixed onto the terminal 125. The terminal 125 may be electrically connected to a power supply 170 (see FIG. 2), which may apply current to the positive electrode terminal and the negative electrode terminal.

The base plate 122 may be provided with one or more frames 121. The frame 121 may be provided in pairs to separate the tray 110 from the base plate 122.

The frame 121 may include one or more column members 121a provided vertically on the base plate 122 and a horizontal member 121b placed on an upper portion of the column member 121a. A plurality of column members 121a may be unidirectionally aligned on the base plate 122. The horizontal member 121b may be placed on the upper side of the unidirectionally aligned column members 121a. The horizontal members 121b may be provided in pairs, and the lower side of the tray 110 may be placed on the horizontal members 121b. The frame 121 may support the lower side of the tray 110, but may space it from the base plate 122. By forming a space between the tray 110 and the base plate 122, the frame 121 may allow heat generated in the battery cell 10 to be effectively dissipated to the outside.

The first sensor 130 may be provided in the terminal 125, and the second sensor 140 may be provided on the upper side of the first and second side plates 123, 124 or on the base plate 122.

Specifically, the first sensor 130 may be provided at the terminal 125 to detect a temperature caused by heat generated in the battery cell 10. When the temperature is a first temperature, the first sensor 130 may transmit information on the first temperature to the controller 150.

In the charging/discharging portion 120 according to an embodiment of the present disclosure, the terminal 125 may be provided on the first and second side plates 123, 124, respectively. The terminal 125 may include a first level 125a, a second level 125b, and a third level 125c on the first side plate 123 in a direction from the top to the bottom of the first side plate 123. A plurality of terminals 125 including the first to third levels 125a, 125b, 125c may be aligned in a transverse direction of the first side plate 123.

The terminal 125 provided in the first to third levels 125a, 125b, 125c may be provided with a first sensor 130. The first sensor 130 may be provided on all of the terminals 125 provided in the first to third levels 125a, 125b, 125c, respectively, or may be spaced apart with one or more of the terminals 125 interposed therebetween. For example, the number of the first sensor 130 provided in each of the first to third levels 125a, 125b, 125c may be from 3 to 20. When there are fewer than 3 first sensors 130 provided in each of the first to third levels 125a, 125b, 125c, it is difficult to accurately measure the temperature of the battery cell 10, and when there are more than 20, it may unnecessarily increase the production cost. Specifically, the first sensor 130 may be 3 to 18, or 4 to 18, or 4 to 16, or 4 to 12, or 4 to 10, or 6 to 15, or 6 to 15.

The terminals 125 provided on the first to third levels 125a, 125b, 125c may include a - terminal and a + terminal electrically connected with a negative electrode terminal and a positive electrode terminal of the battery cell 10, respectively. When the first level 125a in the first side plate 123 is provided with 10 to 100 - terminals, the first level in the second side plate 124 may be provided with 10 to 100 + terminals that are provided in pairs with the - terminals. Further, the second level 125b and third level 125c provided on the first and second side plates 123, 124 may also include - terminals and + terminals to correspond to the first level 125a, respectively.

Specifically, when the first level 125a of the first side plate 123 is provided with 40 - terminals, the first level 125b of the second side plate 124 that is provided in a corresponding position may be provided with 40 + terminals. 5 first sensors 130 may be provided to be spaced apart from each other in the first level 125a of the first side plate 123. For example, the 5 first sensors 130 may be provided approximately equally apart from each other. Furthermore, the first level of the second side plate 124 may also be provided with 5 first sensors 130. The first sensor 130 provided on the first level 125a of the first side plate 123 may be provided in a position corresponding to the first sensor 130 that is provided on the first level of the second side plate 124.

Furthermore, the second level 123b and the third level 123c of the first side plate 123 may also be provided with the first sensor 130 at a position corresponding to the first level 123a, and the second level and the third level of the second side plate 124 may be similarly provided.

Referring to FIG. 5, according to another embodiment of the present disclosure, there may be 5 first sensors 130 provided at each of the first to third levels 125a, 125b, 125c of the first side plate 123, but their positions may be offset from each other. However, the number and arrangement of the first sensors 130 shown in FIG. 5 is by way of example, but are not limited thereto. The positions of the first sensor 130 provided in the first level 125a and the first sensor 130 provided in the second level 125b may be arranged not to correspond to each other. Specifically, the first sensor 130 provided in the second level 125b may be positioned at a position corresponding to a spacing adjacent to each other of the first sensor 130 provided in the first level 125a. Furthermore, the positions of the first sensor 130 provided in the second level 125b and the first sensor 130 provided in the third level 125c may be arranged so that they do not correspond to each other. By designating the positions of the first sensors 130 neighboring each other vertically in a zigzag form so that they are offset from each other, it is possible to measure the temperature of the battery cell 10 provided in the tray 110 with high accuracy without increasing the number of the first sensors 130. The first sensor 130 provided on the second side plate 124 may be provided to correspond to the position of the first sensor 130 provided on the first side plate 123.

Furthermore, the first sensor 130 may be further provided on the sides of the first and second side plates 123, 124. The first sensor 130 may be spaced apart from each other in a height direction on the first and second side plates 123, 124. Specifically, the first sensors 130 provided on the first and second side plates 123, 124 may be provided to correspond to positions where the terminals 125 are provided. For example, the first sensor 130 provided on the left end of the first side plate 123 may be provided in three, aligned with each other to correspond to the first level 125a, the second level 125b, and the third level 125c, respectively, and the first sensor 130 provided on the right end of the first side plate 123 may be provided similarly. The first sensor 130 provided on the left end and the right end of the second side plate 124 may also be provided in positions corresponding to each other. By having the first sensors 130 aligned on the left end and the right end of the first and second side plates 123, 124, according to an embodiment of the present disclosure, the heat generated in the battery cell 10 may be measured more accurately. Furthermore, the first sensor 130 provided on the left end and right end of the first and second side plates 123, 124 may guide the position of the terminal 125 when the terminal 125 is provided, so that the position of the terminal 125 may be accurately designated with a small tolerance.

The second sensor 140 may detect heat generated in the battery cell 10. One or more second sensors 140 may be provided on the upper side of the first and second side plates 123, 124. Two second sensors 140 may be provided on each of the first and second side plates 123, 124, but is not limited thereto. When two second sensors 140 are provided on the upper side of the first and second side plates 123, 124, they may be spaced apart from each other on one side and the other side of the first and second side plates 123, 124.

Further, one or more second sensors 140 may be provided on the base plate 122. The second sensor 140 may be provided on the base plate 122, adjacent to the lower side on which the tray 110 is placed, that is, the column member 121a of the frame 121. The second sensor 140 provided on the base plate 122 may be provided on a portion of the base plate 122 adjacent to the first side plate 123 and a portion adjacent to the second side plate 124, respectively. The second sensor 140 may be provided on the first and second side plates 123, 124 to detect the concentration of the exhaust fume released to the upper side, and may be provided on the base plate 122 on the lower side of the tray 110 to effectively detect the concentration of the exhaust fume released to the lower side.

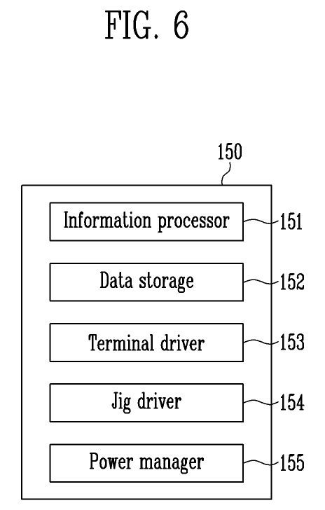

FIG. 6 is a schematic illustration of the controller of FIG. 1.

Referring to FIG. 6, the controller 150 may include: an information processor 151 receiving and processing information transmitted from the first and second sensors; a data storage 152 storing charging and discharging process data recorded in the charging/discharging portion; a terminal driver 153 controlling the electrical connection of the terminal and the battery cell; a jig driver 154 controlling the movement of the first and second side plates; and a power manager 155 controlling on-off of the power of the charging/discharging portion.

The information processor 151 may store the preset temperature and the preset concentration. The information processor 151 may receive information on the first temperature and first concentration transmitted from the first and second sensors, and may compare the information on the first temperature and first concentration with the preset temperature and preset concentration. The information processor 151 may transmit the information on the first temperature and the first concentration to the data storage 152 when the information corresponds to the preset temperature and the preset concentration.

The data storage 152 may store charging and discharging data for the charging or discharging of the battery cell 10 in which the charging and discharging process is performed in the charging/discharging portion 120. The data storage 152 may control the charging and discharging sequence based on the charging and discharging data of the battery cell 10 stored in the data storage 152 when charging and discharging is started again after the fire response is completed, thereby improving the charging and discharging efficiency.

While the storing charging and discharging data in the data storage 152, the terminal driver 153 may control electrical connection of the terminal and the battery cell. Specifically, the terminal driver 153 may determine whether current is flowing between the terminal and the battery cell, or whether there is physical contact between the terminal and the battery cell, and control driving of the terminal. For example, when the terminal applies current to the battery cell, the terminal driver 153 may cause the terminal to be detached from the battery cell after stopping the flow of current being applied to the terminal.

Upon receiving from the terminal driver 153 a state in which physical contact between the terminal and the battery cell is disengaged, the jig driver 154 may reverse the first and second side plates respectively so that a first distance between the first and second side plates increases.

In the case that the tray is discharged from the charging/discharging portion, the power manager 155 may turn off the power delivered to the charging/discharging portion.

In another embodiment of the present disclosure, the controller may further include a tray driver loading the tray from the charging/discharging portion to a stacker crane. When the controller further includes a tray driver, the power manager may move the tray to the stacker crane and then turn the power off.

In another embodiment of the present disclosure, the fire response system for a battery charging and discharging process may further include an alarming portion. The alarming portion may generate an alarm based on information received from any one of the first and second sensors. The first and second sensors may transmit information to the controller so that the controller may control the operation of the charging/discharging portion and the transfer of the tray. In addition, the first and second sensors may transmit information to the alarming portion, so that when the temperature during the charging and discharging process is a first temperature or the concentration of the exhaust fume is a first concentration, the alarming portion may generate an alarm to remind the operator or the like and call for prompt action.

When the alarming portion is provided, the first and second sensors may directly transmit information to the controller, or the first and second sensors may transmit information to the alarming portion, and then the alarming portion may transmit information to the controller.

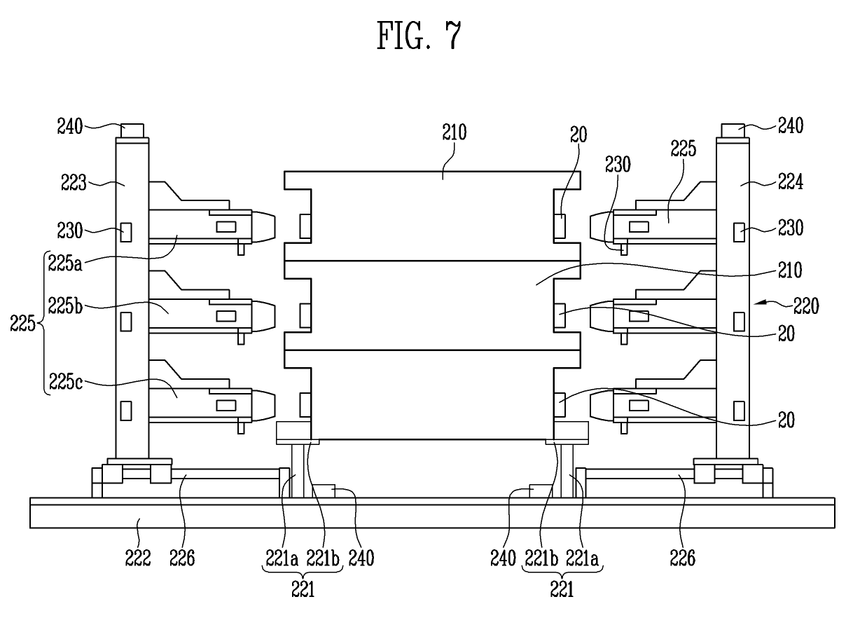

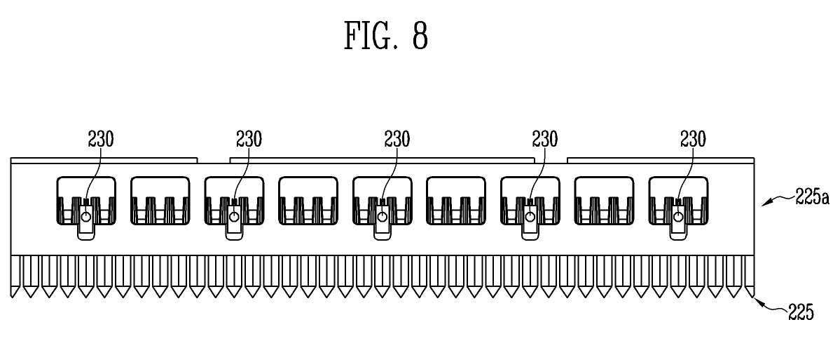

FIG. 7 is a diagram illustrating a tray and a charging/discharging portion according to another embodiment of the present disclosure. FIG. 8 is a diagram illustrating a lower side of the terminal of FIG. 7.

Referring to FIGS. 7 and 8, the charging/discharging portion 220 according to an embodiment of the present disclosure may be provided with a tray 210 having a battery cell 20, and charging and discharging of the battery cell 20 may be performed through a terminal 225 provided in the charging/discharging portion 220. The function of the battery cell 20 and the tray 210 may be similar to the embodiment described above.

The charging/discharging portion 220 may include a base plate 222 including one or more frames 221 on which the tray 210 is placed, and a pair of first and second side plates 223, 224 provided perpendicularly on the base plate 222.

The tray 210 may be provided within the space formed by the base plate 222 and the first and second side plates 223, 224, and the first and second side plates 223, 224 may be moved adjacent to each other by means of a transfer member 226 provided at the lower portion of each of the first and second side plates 223, 224. A terminal 225 provided on each of the first and second side plates 223, 224 may grip and fix a battery cell 20 provided on the tray 210.

The frame 221 may include one or more column members 221a and one or more horizontal members 121b. As the tray 210 is placed on the horizontal members 121b and spaced apart from the base plate 222 by the column member 221a, heat emitted from the battery cells 20 may be effectively released.

Each of the first and second side plates 223, 224 may be provided with a terminal 225 at a position corresponding to each other, wherein, when the terminal 225 provided on the first side plate 223 is connected to the positive electrode of the battery cell 20, the terminal 225 provided on the second side plate 224 may be connected to the negative electrode of the battery cell 10.

The first sensor 230 may be provided in the terminal 225, and the second sensor 240 may be provided on the upper side of the first and second side plates 223, 224 or on the base plate 222. In particular, the first sensor 230 may be provided on a lower surface of the terminal 225.

The terminal 225 may be provided with a first level 225a, a second level 225b, and a third level 225c on the first side plate 223, respectively. Furthermore, the terminal 225 may be provided with a first level, a second level, and a third level even on the second side plate 224 to correspond to the first side plate 223. Since the terminals 225 of the second side plate 224 are aligned in a form corresponding to the terminal 225 provided on the first side plate 223, the first side plate 223 will be described.

In the first side plate 223, the first level 225a may be provided with a plurality of terminals 225 aligned. Further, the second level 225b and the third level 225c may also be provided with a plurality of terminals 225 aligned at positions corresponding to each other, similar to the first level 225a.

The second sensor 230 may be provided on the lower side of the terminal 225. Specifically, the first level 225a may be provided with 1 to 40 terminals, and the second sensor 230 may be provided with 5 terminals spaced apart from each other. For example, the second sensor 230 may be provided on the lower side of the terminal 225, but may be provided on the fifth terminal, the thirteenth terminal, the twenty-first terminal, the twenty-ninth terminal, and the thirty-seventh terminal, respectively.

By having the second sensor 230 according to the embodiment on the lower side of the terminal 225, the temperature of the battery cell 20 may be measured with a higher sensitivity. Furthermore, provided on the lower side of the terminal 225 rather than the upper side, it does not obstruct the vision sensor that is provided on the upper side to check the appearance or contact status of the battery cell 20 or the view of operators, thereby enabling the process to proceed more efficiently.

Furthermore, the second level 225b and the third level 225c may each be provided with a second sensor 230 at a position corresponding to the second sensor 230 provided in the first level 225a.

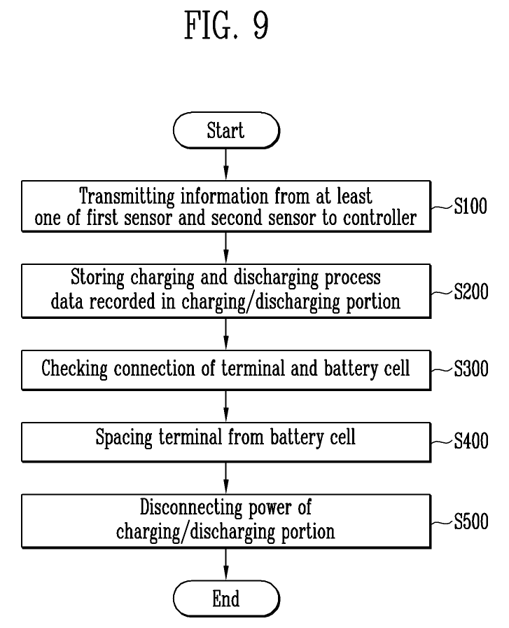

FIG. 9 is a flowchart illustrating a fire response method for a battery charging and discharging process, according to an embodiment of the present disclosure.

Referring to FIG. 9, an embodiment of the present disclosure is a fire response method for a battery charging and discharging process, the method including: transmitting information from at least one of a first sensor or a second sensor to a controller in a process in which one or more battery cells perform a charging and discharging process in a charging/discharging portion S100; storing charging and discharging process data recorded in the charging/discharging portion S200; checking connection of the terminal of the charging/discharging portion and the battery cell S300; spacing the charging/discharging portion from the battery cell S400; and disconnecting power of the charging/discharging portion S500.

The charging and discharging process may be performed by providing the charging/discharging portion with a tray including one or more battery cells. The charging/discharging portion may be provided with one or more terminals, which may be electrically connected to electrode terminals of the battery cells. After the charging/discharging portion is provided with the tray, the terminal of the charging/discharging portion, the negative electrode terminal and the positive electrode terminal of the battery cells may be electrically connected respectively.

The one or more battery cells may be provided in the tray. The charging/discharging portion may include: a base plate including one or more frames on which the tray is placed; first and second side plates provided side by side in a perpendicular direction to a surface of the base plate and facing each other; and one or more terminals provided on the first and second side plates and electrically connected to the battery cells. The first and second side plates may be movable, respectively, such that a first distance between the first and second side plates may vary, the tray may be provided between the first and second side plates, and the battery cell may be electrically connected to the terminal.

The first sensor may be provided on the terminal, and the second sensor may be provided on an upper side of the side plate or on the base plate. By having the first sensor at the terminal, heat generated in the battery cell may be accurately and quickly detected. Furthermore, as the second sensor is provided on the upper side and the lower side of the tray having the battery cells, respectively, the concentration of the exhaust fume generated in the battery cells may be effectively detected.

In the transmitting information to the controller S100, the first sensor may transmit information to the controller when the temperature is a first temperature, and the second sensor may transmit information to the controller when the concentration of the exhaust fume is a first concentration, so that the charging and discharging process of the battery cell may be controlled. The first temperature may be 85°C or higher, and the first concentration may be 5% or higher. When the first temperature or first concentration corresponds to a preset temperature and a preset concentration in the controller, in the storing the charging and discharging process data S200, the controller may control the charging/discharging portion to store the charging and discharging process data. As the SOC state of each battery cell is stored in the storing the charging and discharging process data S200, when the charging/discharging portion is restarted, the charging and discharging may be performed according to the SOC state of each battery cell. Thus, the charging and discharging efficiency may be improved, and overcharging or overdischarging taking place in each battery cell may be avoided.

After the charging and discharging process data is stored, the connection of the terminal and the battery cell may be checked S300, and when the terminal and the battery cell are electrically connected, the flow of current may be blocked, and the terminal may be physically disconnected from the battery cell.

In the spacing the terminal from the battery cell S400, the first and second side plates may be retracted such that a first distance between the first and second side plates increases.

In the disconnecting power of the charging/discharging portion S500, the fire generated by disconnecting the power applied to the charging/discharging portion may be effectively prevented or avoided, and the fire may be prevented from spreading by the power.

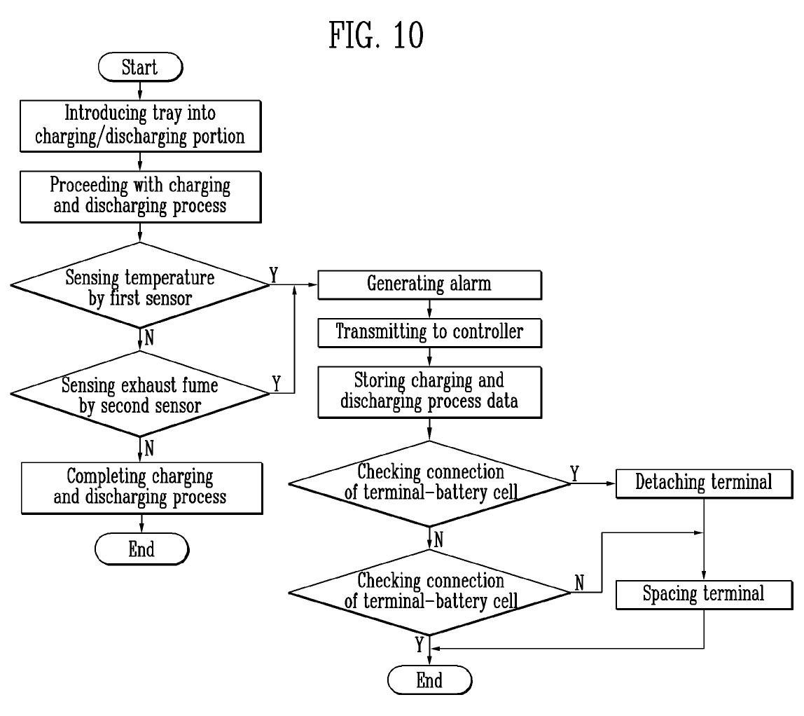

FIG. 10 is a flowchart of a fire response method for a battery charging and discharging process, according to another embodiment of the present disclosure.

Referring to FIG. 10, in a fire response method for a battery charging and discharging process according to an embodiment of the present disclosure, the first and second sensors may further include transmitting information to an alarming portion and generating an alarm in the alarming portion.

In the fire response method for a battery charging and discharging process, according to an embodiment of the present disclosure, a tray may be introduced in the charging/discharging portion, to carry out a charging and discharging process. While proceeding with the charging and discharging process, the first sensor may sense a temperature, and the second sensor may sense exhaust fume. The first sensor may sense the temperature first, and when the temperature is a first temperature, the temperature may be transmitted to the alarming portion to generate an alarm.

The alarming portion may transmit the first temperature to the controller, and the controller may check the connection of the terminal and the battery cell. When the terminal and the battery cell are connected, the controller may separate the terminal from the battery cell and space the terminal apart. When the terminal and the battery cell are separated, the controller may space the terminal from the battery cell. The spacing the terminal from the battery cell may be performed by retraction of the first and second side plates of the charging/discharging portion. After the terminal is spaced apart, the controller may turn off the power of the charging/discharging portion.

When the temperature measured by the first sensor is not the first temperature, the second sensor may sense a concentration of the exhaust fume. When the concentration is not the first concentration, the charging/discharging portion may complete the charging and discharging process for the battery cell.

When the concentration of the exhaust fume measured by the second sensor is the first concentration, the second sensor may transmit the information to the alarming portion. The alarming portion may transmit the first concentration to the controller, and the controller may check the connection of the terminal and the battery cell.

In another embodiment of the present disclosure, the first response method for a battery charging and discharging process may further include, between the spacing the battery cell and the disconnecting the power, loading the tray from the charging/discharging portion to a stacker crane. Prior to the disconnecting the power, the tray with the battery cells may be delivered to the stacker crane to transfer the tray.

Those of ordinary skill in the art to which the present disclosure pertains will understand that the present disclosure may be practiced in other specific forms without altering its technical ideas or essential features. Thus, it should be understood that the embodiments described above are illustrative only in all respects, but not limiting. The scope of the present disclosure is indicated by the scope of the following patent claims rather than by the detailed description above, and the meaning and scope of the claims and all modifications or variations derived from the equivalents thereof are to be construed as falling within the scope of the present disclosure.

What is claimed is:

1. A fire response system for a battery charging and discharging process, comprising:
a tray accommodating one or more battery cells;
a charging/discharging portion including one or more terminals applying current to the battery cells;
a first sensor sensing a first temperature, which is a temperature of heat generated in the battery cell;
a second sensor sensing a first concentration, which is a concentration of exhaust fume released from the battery cell; and
a controller controlling an operation of the charging/discharging portion based on information received from any one of the first and second sensors.

2. The fire response system according to claim 1, wherein the first temperature is greater than or equal to 85°C, and
wherein the first concentration is greater than or equal to 5%.

3. The fire response system according to claim 1, wherein the charging/discharging portion includes:
a base plate including one or more frames on which the tray is placed;
first and second side plates provided side by side in a direction perpendicular to one side of the base plate and facing each other; and
one or more terminals provided on the first and second side plates and electrically connected to battery cells;
wherein the first and second side plates are movable, respectively, such that a first distance between the first and second side plates varies,
wherein the tray is provided between the first and second side plates, and
wherein the battery cell is electrically connected to the terminal.

4. The fire response system according to claim 3, wherein the first sensor is provided in the terminal, and
wherein the second sensor is provided on an upper side of the first and second side plates or on the base plate.

5. The fire response system according to claim 3, wherein the controller includes:
an information processor receiving and processing information transmitted from the first and second sensors;
a data storage storing charging and discharging process data recorded in the charging/discharging portion;
a terminal driver controlling electrical connection of the terminal and the battery cell;
a jig driver controlling movement of the first and second side plates; and
a power manager controlling on-off of power of the charging/discharging portion.

6. The fire response system according to claim 5, wherein the controller further includes a tray driver loading the tray from the charging/discharging portion to a stacker crane.

7. The fire response system according to claim 1, further comprising an alarming portion generating an alarm based on information received from any one of the first and second sensors.

8. A fire response method for a battery charging and discharging process, the method comprising:
transmitting information from at least one of the first sensor or the second sensor to the controller in a process in which one or more battery cells perform a charging and discharging process in a charging/discharging portion;
storing charging and discharging process data recorded in the charging/discharging portion;
checking connection of the terminal and the battery cell;
spacing the terminal from the battery cell; and
disconnecting power of the charging/discharging portion;
wherein the first sensor transmits information to the controller when a temperature is a first temperature, and
wherein the second sensor transmits information to the controller when a concentration of exhaust fume is a first concentration.

9. The fire response method according to claim 8, wherein the first temperature is greater than or equal to 85°C, and
wherein the first concentration is greater than or equal to 5%.

10. The fire response method according to claim 8, wherein the charging and discharging process is performed by providing the charging/discharging portion with a tray having one or more battery cells, and
wherein the charging/discharging portion is provided with one or more terminals to be electrically connected with an electrode terminal of the battery cell.

11. The fire response method according to claim 8, wherein the transmitting information to the controller further includes transmitting, by the first and second sensors, information to an alarming portion and generating an alarm in the alarming portion.

12. The fire response method according to claim 8, further comprising, between the spacing from the battery cell and the disconnecting power, loading the tray from the charging/discharging portion to a stacker crane.

13. The fire response method according to claim 8, wherein the one or more battery cells are provided in a tray,
wherein the charging/discharging portion includes:
a base plate including one or more frames on which the tray is placed;
first and second side plates provided side by side in a direction perpendicular to one side of the base plate and facing each other; and
one or more terminals provided on the first and second side plates and electrically connected to battery cells;
wherein the first and second side plates are movable, respectively, such that a first distance between the first and second side plates varies,
wherein the tray is provided between the first and second side plates, and
wherein the battery cell is electrically connected to the terminal.

14. The fire response method according to claim 13, wherein the first sensor is provided in the terminal, and
wherein the second sensor is provided on an upper side of the side plate or on the base plate.
